(19) United States
(12) Patent Application Publication
(10) Pub. No.: US 2018/0285976 A1
(43) Pub. Date: Oct. 4, 2018

(54) METHOD, COMPUTER PROGRAM PRODUCT AND SYSTEM FOR PROACTIVE INSURANCE MARKETING

(71) Applicants: Tammy Dye, Bothell, WA (US); Kim Garland, Sammamish, WA (US); Elisabeth Power, Shoreline, WA (US); Shawn Anderson, Seattle, WA (US)

(72) Inventors: Tammy Dye, Bothell, WA (US); Kim Garland, Sammamish, WA (US); Elisabeth Power, Shoreline, WA (US); Shawn Anderson, Seattle, WA (US)

(73) Assignee: Safeco Insurance Company of America

(21) Appl. No.: 11/555,026

(22) Filed: Oct. 31, 2006

(51) Int. Cl. G06Q 40/08

(52) U.S. Cl. CPC G06Q 40/08

(57) ABSTRACT

A method, computer program product and system are provided for automatically detecting and notifying a party of a change in the party's insurance needs without the need for user intervention, on the part of an agent or the party him-, her-, or itself. Prospective customers can be identified through marketing, or an insurance provider may execute software that is configured to monitor one or more data sources that include information associated with the party and/or the party's environment. Upon detecting a triggering event that indicates a change in the party's insurance needs, the software may automatically notify the party of the change and provide a recommendation for a change in the party's insurance coverage resulting from the change in the party's insurance needs. The notification may further include a bindable quote associated with the recommendation, as well as a means by which the party can accept the recommendation and quote.

### CROSS-REFERENCE TO RELATED APPLICATIONS

This application is related to U.S. application entitled Method, Computer Program Product and System for Proactively Notifying of a Change in a Party's Insurance Needs, filed concurrently herewith, the contents of which are hereby incorporated herein in their entirety.

### FIELD OF THE INVENTION

In general, exemplary embodiments of the present invention relate to the changing insurance risks and needs of an individual and, in particular, to marketing insurance by presenting bindable quotes for defined coverage directly to customers without an exchange of application information.

### BACKGROUND OF THE INVENTION

From each generation to the next, the amount and availability of information continues to increase. Individuals and companies today have countless means for accessing information that may affect them or those associated with them. With the advent of the World Wide Web, almost no piece of information is unattainable. Given the time, there is almost nothing that a person cannot educate themselves on fairly easily. This can range from something as easy as learning how to knit (http://www.learntoknit.com/), to something as complicated as learning how fingerprint scanners work (http://computer.howstuffworks.com/fingerprint-scanner.htm).

With this increased availability of information, one might assume that individuals are making better, more informed decisions regarding various aspects of their life. This may include, for example, getting the best price on a house they are interested in purchasing based on information obtained regarding the appraised value of houses in the surrounding area and the sale price of similar houses recently sold. It may also include getting the best deal on a car by using various web sites to compare the prices and features of cars offered by various manufacturers. Another area in which one might assume that individuals and companies are making better decisions given the wealth of information available to them is insurance. Again, given the time, an individual or company likely has available to them sufficient information to determine what insurance policies should be obtained and at what coverage amount.

However, juxtaposed with this increased availability of information is the fact that individuals seem to be moving at a faster and faster pace with each new generation. Consumers may not have, or be willing to take, the time to take advantage of all of the resources that are now available to them. As a result, consumers are frequently still making poor decisions, including poor insurance decisions. These poor decisions may be based on a failure to perceive a potential or actual gap in their insurance coverage (e.g., assuming incorrectly that wind coverage will cover damage caused by flooding due to a hurricane). Alternatively, the individual or company may recognize the lack of coverage, but may lack the knowledge as to how to fix or resolve the known gap, and/or the time, or desire to spend the time, to find out how to remedy the known lack of coverage.

The issue is particularly problematic where changes occur in an individual's life or environment, or in the life or environment of a company, especially during a term of an existing insurance policy, that affect the overall insurance needs or risk exposure of that individual or company. In order for the customer (i.e., an individual, company, or other entity covered by an existing insurance policy, or a potential insurance customer) to make a good decision at that point, the customer must not only recognize that a life or economic event has occurred that necessitates the consideration (or re-consideration) of the customer's insurance needs (and, if already insured, the customer's initial insurance decision), but must also know what to do as a result of this life or economic event. This may include, for example, knowing who to call or contact, what questions to ask, what information to obtain, and the like. Once the insured has figured out all of that, it is then necessary to make a decision, such as selecting between various insurance coverage options available, based on the information obtained. The foregoing process has the potential to be quite onerous for the insured and it is very likely that the insured will make a poor decision at one or more of these steps, including a decision to forego coverage, or to put off or neglect the desirability of making a decision.

In some circumstances a diligent insurance agent may take some of the onus off of an insured by personally learning of a change in the insured's (i.e., a current insurance customer's) life or environment, and contacting the insured to discuss any changes in insurance coverage that may be necessary or beneficial. In one instance this may be the result of the agent having a personal relationship with the insured, such as when they both lived in the same small town. In another instance, the agent may send out a survey or questionnaire to determine whether any of the information the agent has regarding the insured has changed. In many cases, the agent will only follow-up in this manner when it is time for the insured to renew an existing policy. However, the insured's needs may change in the middle of a policy, increasing the potential for the insured to be inadequately covered and, therefore, unnecessarily exposed to additional risk. In addition, the agent's time or ability to learn about changes and to consider multiple factors that may cause a change in the insured's insurance needs or risk exposure at one time may be limited.

A need, therefore, exists, for a technique for proactively detecting and notifying an insured of possible changes in the insured's insurance needs or risk exposure that takes the onus off of the customer or insured and increases the likelihood that the customer or insured will make good decisions with regard to insurance coverage.

In addition to the foregoing, insurance providers (including producers (i.e., agents or brokers) and insurance carriers) often encounter resistance among prospective customers to lengthy processes that may be required to provide application information requested by the insurance carrier for underwriting purposes. Potential customers interested in insurance may abandon the process of applying for insurance coverage when the individual runs out of time or patience. Even when such customers receive direct solicitation offers, they must still provide additional information in order to receive a bindable quote.

A further need thus exists for enabling a provider of insurance to create a better, more attractive offer of coverage for a person who may be interested in acquiring insurance coverage, or an insured whose insurance needs have changed, and for the individual to be able to obtain coverage in a quick and efficient manner.

### BRIEF SUMMARY OF THE INVENTION

In general, exemplary embodiments of the present invention provide an improvement over the known prior art by, among other things, providing a method, computer program product and system for conducting risk analysis and/or coverage recommendation analysis related to a prospective purchaser without requesting or obtaining any underwriting information specific to the analysis from the prospective purchaser, and subsequently contacting the prospective purchaser in a manner which presents to the prospective purchaser a bindable quote for the proposed insurance coverage, as well as a means by which the party can accept the quote. According to such a process, the prospective purchaser is not asked for any underwriting information specific to the coverage recommendation, the insurance provider relying on information about the prospective purchaser available in its own files or available from accessible data sources. Prospective purchasers may include present insureds whose needs are monitored, those who have different coverage with the insurance provider, or those whom the insurance provider approaches as new customers.

According to one aspect of the invention, a method is provided of proactive insurance marketing. In one exemplary embodiment, the method includes: (1) identifying a customer of an insurance policy; (2) conducting an analysis of the customer to generate a proposed coverage; (3) generating a bindable quote for the proposed coverage; and (4) presenting the proposed coverage and corresponding bindable quote to the customer. In this exemplary embodiment, no underwriting information specific to the proposed coverage is obtained from the customer prior to presenting the customer with the proposed coverage and corresponding bindable quote.

According to another aspect of the invention, a computer program product is provided for proactive insurance marketing. The computer program product contains at least one computer-readable storage medium having computer-readable program code portions stored therein. The computer-readable program code portions of one exemplary embodiment include: (1) a first executable portion for identifying a customer of an insurance policy; (2) a second executable portion for conducting an analysis of the customer to generate a proposed coverage; (3) a third executable portion for generating a bindable quote for the proposed coverage; and (4) a fourth executable portion for presenting the proposed coverage and corresponding bindable quote to the customer. In this exemplary embodiment, no underwriting information specific to the proposed coverage is obtained from the customer prior to presenting the customer with the proposed coverage and corresponding bindable quote.

According to yet another aspect of the invention, a system is provided for proactive insurance marketing. In one exemplary embodiment, the system includes a processor and a memory in communication with the processor and storing an application thereon. In one exemplary embodiment, the application is configured, upon execution by the processor, to: (1) identify a customer of an insurance policy; (2) conduct an analysis of the customer to generate a proposed coverage; (3) generate a bindable quote for the proposed coverage; and (4) present the proposed coverage and corresponding bindable quote to the customer. In this exemplary embodiment, no underwriting information specific to the proposed coverage is obtained from the customer prior to presenting the customer with the proposed coverage and corresponding bindable quote.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as an insurance provider computing device in accordance with exemplary embodiments of the present invention;

FIG. 3 is a flow chart illustrating the steps which may be taken in order to notify a party of a change in his or her insurance needs, in accordance with an exemplary embodiment of the present invention; and

FIG. 4 is a flow chart illustrating the steps which may be taken for proactive insurance marketing in accordance with an exemplary embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Overview:

As noted above, in general, exemplary embodiments of the present invention provide a method, computer program product and system for automatically notifying a party of a change in the party's insurance needs. In particular, according to exemplary embodiments, an insurance provider may agree to monitor (or choose unilaterally to monitor) one or more data sources including information associated with the party, or the party's environment, using software operating on a computing device associated with the insurance provider. The insurance provider may further agree to automatically notify the party when the software detects a triggering event that indicates a change in the party's insurance needs. In notifying the party, the insurance provider may further agree to provide one or more recommendations for a change in the party's insurance coverage based on the change in the party's insurance needs, as well as a bindable quote associated with respective recommendations. The party may be a present insured of the insurance provider, a party not presently insured by the insurance provider who contracts with the insurance provider for the monitoring service, or a party identified by the insurance provider as a potential customer.

To illustrate, for example, the software executed by the insurance provider may monitor the credit card records of a particular insured. Upon detecting the purchase of diapers, or similar products that may indicate that the insured has had or is about to have a child, the insurance provider may send an email to the insured recommending that the insured add the new child to their existing insurance coverage, or that the insured increase his or her umbrella coverage (i.e., the software operating on the insurance provider's computing device may automatically transmit the email to the insured including the recommendation). The email may further include a bindable quote associated with the addition of a dependent to the insurance policy, as well as a means by which the insured can accept the recommendation and bindable quote if desired. The means may include, for example, a link to a web site through which the insured can perform the necessary action to accept the recommendation and quote.

The method of exemplary embodiments provides a benefit over the diligent agent by, among other things, enabling countless additional data sources to be accessed electronically, efficiently and according to a predetermined schedule, as well as enabling numerous factors affecting a party's insurance needs and risk exposure to be considered all at one time. The method of exemplary embodiments further provides for increased consistency among notifications and recommendations, since it is not dependent upon the diligence of the particular agent involved. As a result of the foregoing, according to exemplary embodiments, better, more accurate and more consistent recommendations can be provided.

### Overall System and Insurance Provider Computing Device

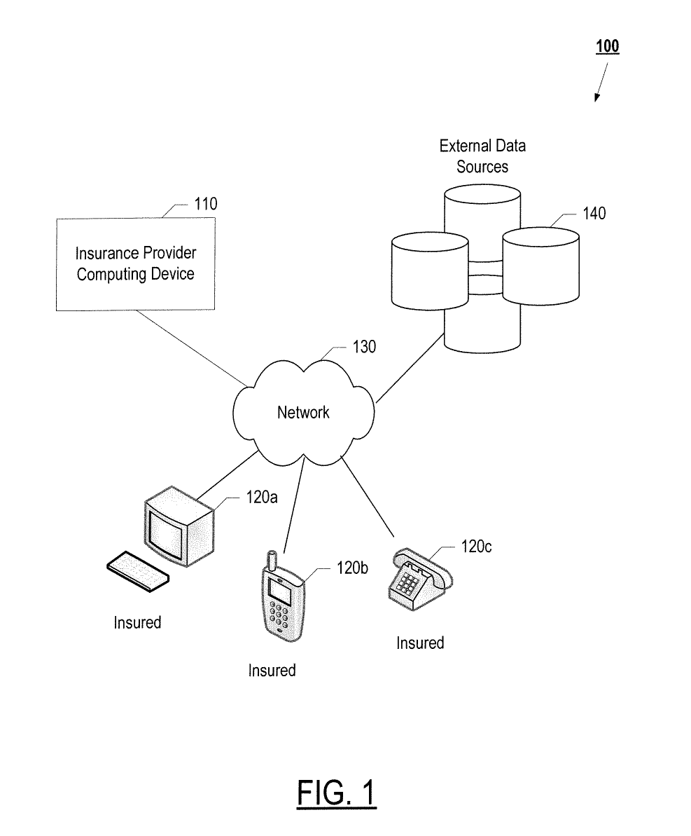

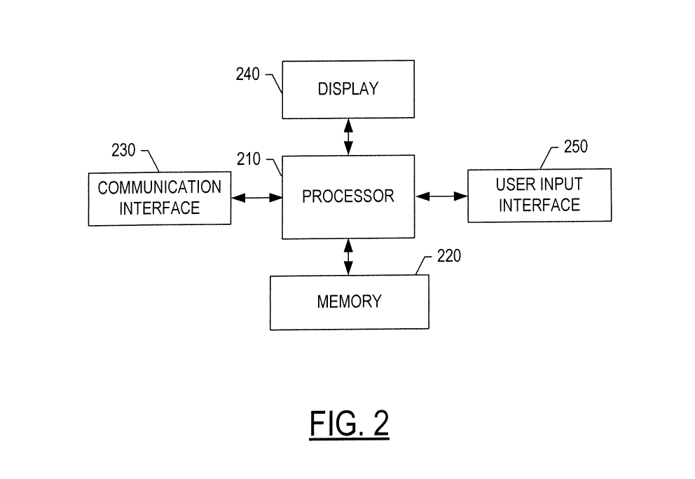

FIG. 1 provides a block diagram of a system for automatically notifying a party of a change in the party's insurance needs 100 in accordance with various embodiments of the present invention. As may be understood from this figure, the system 100 may include an insurance provider computing device 110, which is discussed in more detail below with reference to FIG. 2, and which may include, for example, a server or similar electronic device, operated by an insurance provider or a third-party associated with the insurance provider. According to exemplary embodiments of the invention the computing device 110 may be configured to access one or more external data sources 140 via a network 130 (e.g., a Local Area Network (LAN), Wide Area Network (WAN), the Internet, or the like) for the purpose of monitoring the external data sources 140 for the occurrence of a triggering event.

The external data sources 140 may include any data source that includes information that may be associated with a party and/or the party's environment and that may provide an indication of the party's insurance needs and/or risk exposure. For example, the external data sources 140 may include a combination of databases including information, such as, Internal Revenue Service (IRS) returns or tax records, bank deed records, satellite images, medical records, purchasing records (e.g., credit card records), product registration records, birth records, and the like. As is discussed in more detail below, the occurrence of a triggering event may be detected based on the appearance of certain information or data in one or more of these external data sources 140 that indicates that a party's insurance needs may have changed.

The system 100 may further include one or more communications devices 120a, 120b, 120c, which are in communication with the insurance provider computing device 110 via the same or different network 130, and which are associated with a respective one or more insured (i.e., individuals or companies under an existing insurance policy). The communications devices 120a, 120b, 120c may include, for example, some combination of personal computers (PCs), laptops, personal digital assistants (PDAs), cellular telephones, or similar electronic devices, capable of receiving a notification from the insurance provider computing device 110, for example, in the form of an email, text, voice or multimedia message, regarding a change in the insured's insurance needs.

Referring now to FIG. 2, a block diagram of an entity capable of operating as an insurance provider computing device 110 is shown in accordance with one embodiment of the present invention. The entity capable of operating as an insurance provider computing device 110 may include various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as an insurance provider computing device 110 may generally include means, such as a processor 210 connected to a memory 220, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention. In particular, according to exemplary embodiments of the present invention, the memory may store computer-readable program code portions for monitoring one or more data sources including information about a party and/or the party's environment, detecting the occurrence of a triggering event that indicates a change in the party's insurance needs, and automatically notifying the party of the change.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like (e.g., for transmitting a notification of a change in the party's insurance needs and including a recommendation for a corresponding change in the party's insurance coverage, and for receiving an indication of interest in the recommendation on the part of the notified party), as well as at least one user interface that can include a display 240 and/or a user input interface 250. The user input interface, in turn, can comprise any of a number of devices allowing the entity to receive data from a user, such as a keypad, a touch display, a joystick or other input device.

### Method of Providing Notification of a Change in a Party's Insurance Needs

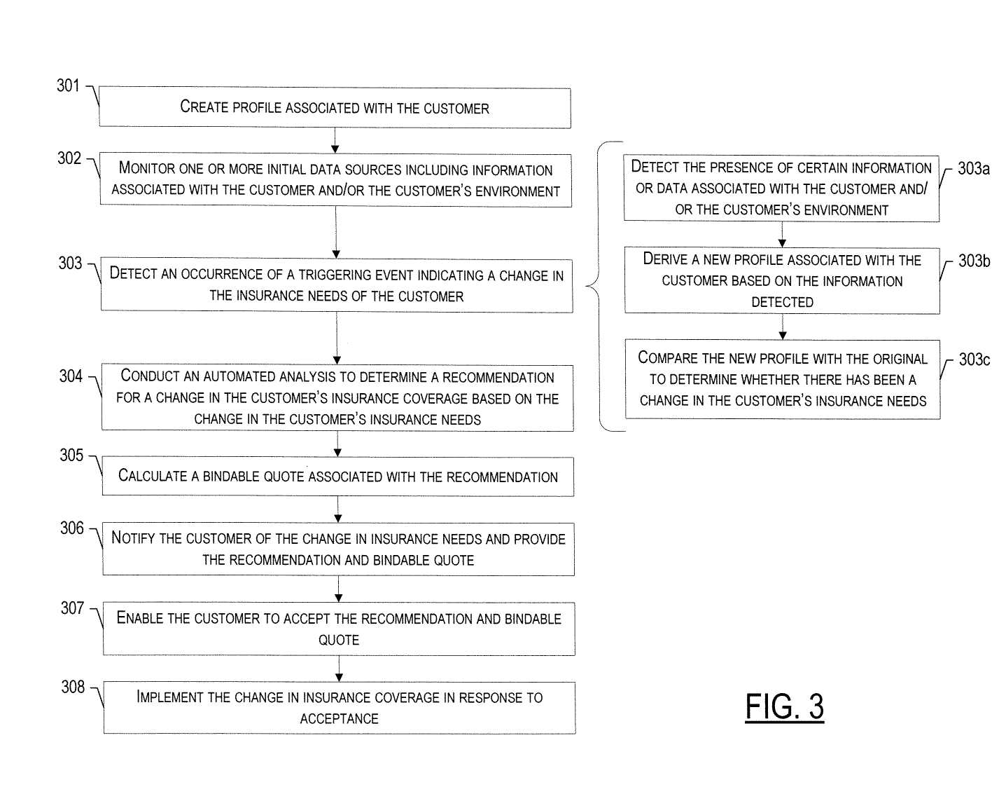

Reference is now made to FIG. 3, which provides a flow chart illustrating the steps which may be taken, according to exemplary embodiments of the invention, in order to automatically notify a party of a change in his, her or its insurance needs, and to provide the party with a recommendation for a change in insurance coverage based on the change in insurance needs. In one exemplary embodiment, the party may be currently insured by the insurance provider notifying the party of a change in his, her or its insurance needs (i.e., a current customer). Alternatively, the party may be a prospective customer of the insurance provider. In either case, as shown, according to one exemplary embodiment, the process may begin in Step 301 when a profile associated with the party (hereinafter “the customer”—current or prospective) is created. In general, the profile may include an overall picture or summary of the customer's insurance needs and risks based on various factors relating to the customer and the customer's environment (e.g., credit scores, property values, etc.). The profile may be created based on information obtained from an application completed by the customer and/or by accessing various data sources for information related to the party (i.e., in order to reduce or eliminate altogether the need to obtain information directly from the customer).

Once the profile has been created, an optional step (not shown in FIG. 3) may then be to obtain permission from the customer to monitor one or more data sources including information about the customer and the customer's environment. As discussed above, the purpose of the monitoring would be to detect a change in the customer's insurance needs or risk exposure, so that the customer can be notified of these changes and of possible ways to alter their insurance coverage in response to the change without having to take any affirmative action. As a result, exemplary embodiments of the present invention take the onus off of the customer (and the insurance agent for that matter) to recognize that a life or economic event has occurred that may cause certain aspects of the customer's insurance coverage to no longer be sufficient or, alternatively, to no longer be necessary. However, in order to optimally monitor for the occurrence of a triggering event, access may be desired to certain data sources that are more protected than others (e.g., data sources including information on a customer's credit score). In order to access these data sources, therefore, the insurance provider may be required to obtain specific permission from the customer.

In one exemplary embodiment, the insurance provider may warrant the effectiveness of the monitoring process. In accordance with this embodiment, by providing permission, the customer may also be protecting him-, her-, or itself from liability for events or problems that may occur after a change in insurance needs has occurred, and for which the customer was not protected because of the change, but before the insurance provider notified the customer of the change and provided the opportunity to change the customer's insurance coverage accordingly. To illustrate, consider the scenario where a customer, who gave permission to monitor for triggering events in exchange for retroactive indemnification, purchased a boat and assumed, incorrectly, that the boat was covered under his, her or its current property coverage. If the boat were to be destroyed before the insurance provider notified the customer of the change in his, her or its insurance needs, the insurance provider may be responsible for the loss. In other words, the insurance provider would retroactively cover the loss due to its failure to timely detect and notify the customer of the change.

In addition, in one exemplary embodiment, the contract between the customer and the insurance provider may establish a specific schedule or plan for when and/or how frequently the insurance provider is responsible for monitoring the data sources for the occurrence of a specific event. For example, it may be established that the insurance provider need only monitor IRS returns one or twice a year, while it may be necessary to monitor the databases including credit card information on a daily or weekly basis.

Returning to FIG. 3, the next step is to begin monitoring the one or more initial data sources including information associated with the customer and/or the customer's environment. (Step 302). As discussed above with reference to FIG. 1, the data sources may include, for example, a combination of databases including information, such as, IRS returns or tax records, bank deed records, satellite images, medical records, purchasing records (e.g., credit card records), product registration records, birth records, the customer's own profile (e.g., for information such as age of the customer's dependents), and the like.

According to one exemplary embodiment, the monitoring of one or more external data sources may be performed automatically by the insurance provider computing device 110 (e.g., a server associated with the insurance provider), discussed above, that is running a computer program or software application configured to automatically, periodically, and systematically check specific data sources for the appearance of certain information or data. For example, the computer program or application may, on a daily or weekly basis, perform a word search of a database including a grocery store's scan card records (e.g., listing all of the groceries purchased by an individual) for words like “diaper” or “formula” (i.e., indicating that the customer may have had or is planning on having a baby). Alternatively, or in addition, the computer program product or application may be configured to access a customer's IRS return, extract from the IRS return information associated with the customer's income, compare the extracted information with income information previously extracted (e.g., from the previous year's IRS return), and create an alert or flag if the absolute value of the difference is more than a certain predefined threshold.

As one of ordinary skill in the art will recognize, the foregoing merely provides a few examples of the manner in which the external data sources may be monitored for the purpose of detecting a triggering event. Other techniques may similarly be used without departing from the spirit and scope of exemplary embodiments of the present invention.

At some point during the monitoring process, in Step 303, the occurrence of a triggering event that indicates that there has been a change in the insurance needs of the customer may be detected by the computer program or software application (i.e., without any user intervention). According to exemplary embodiments, a triggering event may be any life or economic event that causes a change in the overall insurance needs or risk exposure of a customer. Examples of triggering events may include the purchase of an item eligible for insurance coverage (detectable, for example, through monitoring product registration databases), a change in the level of income associated with the customer (detectable, for example, through monitoring IRS returns), or a change in status affecting the party's risk exposure, to name a few. More specific examples of life events that may constitute a triggering event may include where a dependent of the customer turns a predetermined age (e.g., 16), or the customer purchases a boat or wins the lottery. More specific examples of economic events that may constitute a triggering event may include a rise in inflation (indicating that a property damage limit may have become insufficient to replace the property) or an increase in the risk of a catastrophic event (such as a prediction of storm frequency by a reputable organization).

As shown in FIG. 3, in one exemplary embodiment, detecting the occurrence of a triggering event may include several sub-steps. In particular, in Step 303a, the presence of certain information or data associated with the customer and/or the customer's environment may first be detected in one or more of the data sources being monitored. For example, the computer program or software application may detect the customer's name in a boat registration database indicating that the customer has purchased a boat. As a further example, the computer program or software application may see, based on monitoring various databases including information on property taxes, that the value of the houses in the customer's zip code have increased or, based on monitoring the government's inflation records, that inflation has drastically increased.

Upon detecting the presence of this information, the application operating on the insurance provider computing device may derive a new profile associated with the customer based on the information detected in order to determine whether and how the information affects the overall picture of the customer's insurance needs and risks. (Step 303b). Continuing with the above examples, where it is detected that the customer has purchased a boat, a new profile may be generated for the customer wherein the value of the customer's property is increased by the amount of the boat. Similarly, where the value of the houses in the customer's zip code has substantially increased, a new profile may be generated, wherein the value of the customer's property is increased in order to reflect the increase in the replacement cost of the customer's house.

In Step 303c, the new profile is compared to the original profile (created in Step 301) in order to determine whether and to what extent the change in the customer's profile results in a change in the customer's insurance needs. For example, it may be determined whether the change in the value of the customer's property due to either the purchase of the boat or the increase in the replacement cost of the customer's house was sufficient to cause a change in the customer's insurance needs.

According to one exemplary embodiment, a triggering event results where it is determined, based on the above three sub-steps, that the information detected in one or more of the external data sources, which indicates a possible change in the customer's life or environment, has caused a change in the customer's overall insurance needs. However, as one of ordinary skill in the art will recognize, the foregoing sub-steps may not be required in order to detect all triggering events. In other words, the appearance of certain information in one or more external data sources may automatically indicate a triggering event or a change in the customer's insurance needs without having to create a new profile. For example, if a dependent of the customer turns some predefined age (e.g., 16), this may automatically be seen as a triggering event without requiring the creation of a new profile. Of course, a new profile may be created at a later stage for the purpose of creating a recommendation of a change in the customer's insurance coverage in light of the change in his or her insurance needs (see below).

In response to detecting the occurrence of a triggering event, an automated analysis may be conducted, in Step 304, in order to determine one or more recommendations for a change in the customer's insurance coverage based on the change in the customer's insurance needs. Changes to the customer's insurance coverage may include, for example, the addition of a new insurance product (e.g., adding flood insurance where it is detected that the flood plain boundaries were redrawn to include the customer's property), an elimination of an existing insurance product (e.g., eliminating collision and comprehensive coverage where it is detected that the customer's vehicle is more than a certain number of years old), or a change in the coverage amount of a particular insurance product (e.g., increasing the value of an umbrella based on a spike in inflation).

In one exemplary embodiment, in order to perform the automated analysis, additional information pertinent to the customer's insurance coverage and needs may be retrieved from one or more additional data sources. The additional information may include any information that is necessary or beneficial for running a recommendation model, discussed below. The additional data sources accessed may include, for example, databases including information such as credit card records, motor vehicle records, birth records and the like. These data sources may be the same or different from those monitored for the purpose of detecting a triggering event in Step 302 above. To illustrate, in one exemplary embodiment, where the triggering event comprises a dependent of the customer turning some predetermined age necessary to operate a motor vehicle, additional data sources may be accessed in order to determine whether the customer has purchased a car, and/or whether the customer's dependent has obtained a license.

According to one exemplary embodiment, the automated analysis conducted to determine one or more recommendations for a change in insurance coverage may involve accessing a multi-dimensional database in order to determine what coverage types and amounts other, similarly-situated customers have previously obtained. Among the data elements that may be included in this database are: characteristics regarding various categories of risk, business or personal insurable risk, such as loss of real or personal property, loss of business income or extra expense required to continue business operations or a residential dwelling, damage to business or personally used vehicles, liability for the damage or injury arising from the ownership or operation of a business, dwelling, vehicle or other equipment or watercraft, injury to employees and other types of financial loss resulting from the operation of a business or maintaining a private residence. In addition, the database may contain information concerning types of businesses (e.g., SIC and/or NAICS codes, or Industry and proprietary classification codes), as well as various combinations of insurance products and their applicability to business and personal risk including, Personal and Commercial automobile Insurance, Businessowners and Homeowners policies of various types, Property Insurance, General and Specialty Liability policies, Workers Compensation insurance policies and Umbrella or excess liability policies. Various ancillary policies and coverage may also be included such as Flood Insurance, Earthquake Insurance, Equipment breakdown Insurance, watercraft insurance and Inland Marine policies covering tools and equipment, and policies covering other personal recreational and business equipment. All practical combinations of coverage options may further be included in the database, such as available limits, deductible options and supplemental coverage options.

According to one exemplary embodiment, superimposed on the product and coverage data may be rules concerning product availability in each jurisdiction, minimum and maximum limits available, special regulatory or statutory coverage requirements, assessments of the adequacy and reasonability of coverage and limits requested by the user and the insurance provider's market appetite for various requested coverage and limits. An additional dimension of the database of one exemplary embodiment may be information on customer purchasing preferences and propensities based upon data mining and analysis of historical customer behavior patterns. For example, the database may provide information on coverages and limits purchased more often than not by prior customers whose businesses or personal situations are similar to a current customer's.

The data mining and statistical analysis required to draw such information from historical customer data are well known in the field, and may include, for example, through the use of commercially available software tools, such as SAS software provided by SAS (www.sas.com).

In one exemplary embodiment, in order to perform Step 304, business rules and algorithms may be applied to match exposures and risk of loss for the customer to the appropriate products, coverage, limits and options which best meet the needs of the customer across the full range of products and options. The result of this analysis, according to exemplary embodiments, is a real time, comprehensive assessment of the customer's needs matched to an optimal product and coverage portfolio providing a full range of insurance products ready for final quoting and binding by the user. During the analysis, gaps in coverage may be highlighted and overlaps may be eliminated by precise matching of need to products.

According to one exemplary embodiment, multiple recommendations may be generated in this step. These recommendations may span a range of coverage levels ranging from Low End coverage (i.e., minimal protection) to Middle of the Road coverage (i.e., coverage obtained by a majority of customers) and further to High End coverage (i.e., extensive and likely expensive coverage). In one exemplary embodiment, one of the multiple proposed coverage changes may be the actual or preferred recommendation, while the others may be alternatives for selection by the customer.

Once the one or more recommendations have been generated, in one exemplary embodiment, a bindable quote may be calculated for each recommendation based on one or more underwriting and rating models. (Step 305). As is known in the industry, insurance providers utilize one or more such models favored by the respective provider. Exemplary embodiments of the present invention can be utilized to advantage with all such models. The computer program or software application operating on the insurance provider computing device may then be configured, upon execution, to automatically notify the customer of the change in his or her insurance needs. (Step 306). According to one exemplary embodiment, this may involve transmitting an email, text, multimedia, or automated voice message to the customer's communications device (e.g., cellular telephone, personal digital assistant (PDA), personal computer (PC), laptop, or the like). In the alternative, a representative of the insurance provider may contact the customer in person.

In one exemplary embodiment, the notification may include only an indication that the customer's insurance needs have changed (e.g., a text message stating “We noticed that you may have had a new addition to your family. This may cause some changes in your optimal insurance coverage. Please contact us if you would like to discuss it further.”). In this exemplary embodiment, the customer may be required to first provide an indication of some interest in receiving a recommendation before a recommendation or bindable quote will be communicated. In this exemplary embodiment, Steps 304 and 305 may not be performed until after Step 306 and only upon receipt of some indication of interest. Alternatively, in another exemplary embodiment, the notification may include the one or more recommendations, but not the corresponding bindable quotes. As above, in this exemplary embodiment, the customer may be required to first provide an indication of some interest in one or more of the recommendations provided before the corresponding bindable quotes are communicated and, in some instances, even calculated. Finally, in yet another exemplary embodiment, the notification may include both the recommendations and the bindable quotes, without requesting any information from the customer.

According to one exemplary embodiment, the manner in which the customer is notified of the change and the content of the notification (i.e., the presence or absence of one or more recommendations and corresponding bindable quotes) may be determined by the customer upon agreeing to this monitoring service.

Returning to FIG. 3, according to one exemplary embodiment, in Step 307, the customer is enabled to then accept one of the recommendations and corresponding bindable quote. In one exemplary embodiment, this may involve simply providing the customer with a phone number that he or she can call in order to convey his or her acceptance, optionally along with some sort of confirmation number that can be used to verify that the customer is authorized to make the requested change. Alternatively, if the notification is provided via an email, text or multimedia message, the email, text or multimedia message may include a link to a website that the customer can access in order to accept the recommendation and bindable quote provided and to provide any necessary information to complete the process. If an in-person visit is made, the customer may be able to sign a policy document.

In one exemplary embodiment, the customer may agree to automatically accept the recommendation and the bindable quote upon the occurrence of a triggering event without having to take any affirmative steps in response to receiving the notification. For example, the customer may agree upfront that when the customer's son turns 16, the customer's coverage will automatically change to include the son.

In yet another exemplary embodiment (not shown), the customer may be able to request a variation or modification of one or more of the recommendations provided. For example, the customer may request a higher deductible for a first-layer policy, or a larger amount of umbrella coverage. In this exemplary embodiment, if the customer-specified parameter is acceptable to the insurance provider, a new bindable quote may be generated for the new, modified recommendation.

Finally, assuming the customer has accepted one of the recommendations (either one originally proposed or a variation thereof) and corresponding bindable quote, in Step 308, the change in the customer's insurance coverage is implemented in response to the acceptance. In particular, according to exemplary embodiments, this may include affecting the change to the policy and, possibly, transmitting a bill or refund to the customer in light of the new premium.

### Method of Proactively Marketing Insurance

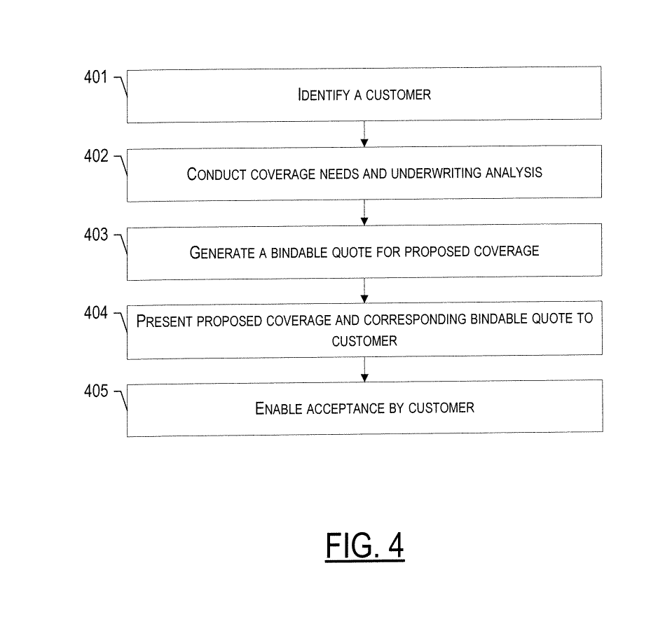

A further embodiment of the invention not necessarily involving the monitoring process is shown in FIG. 4. In particular, FIG. 4 illustrates the steps which may be taken in order to proactively market an insurance product to an individual who may or may not already be a customer of the insurance provider conducting the marketing efforts. As shown, this process may begin at Step 401 where a customer for a new or modified insurance policy is identified. In one exemplary embodiment this may involve accessing one or more data sources (internal or external to the insurance provider) in order to locate an individual who seems particularly suitable for a specific insurance product. The description of foregoing exemplary embodiments includes suitable individuals. In addition, a customer might be located using, for example, census records indicating that a dependent of the individual has reached a predetermined age. In one exemplary embodiment, a customer may be identified using marketing techniques and/or a prescreened list of individuals or companies having certain characteristics. Alternatively, or in addition, such a customer may be identified based on a particular pattern of displayed behavior. For example, if an insurance provider notices that a particular person tends to buy a new car every two years, the person may be identified as a customer for additional or new auto insurance every two or so years.

Once the customer has been identified, a coverage needs and underwriting analysis, for example of the kind discussed above, may then be performed in order to determine from what coverage types and amounts the customer would most benefit, as well as for what coverage types and amounts the customer may qualify, all without requesting or receiving any information directly from the customer that is necessary or would be used for performing such an analysis (i.e., without receiving any underwriting information specific to generating a proposed coverage and bindable quote). (Step 402). In particular, in one exemplary embodiment, the analysis may involve taking the information gathered from one or more data sources relating to the customer and accessing the multi-dimensional database discussed above to determine what coverage types and amounts other, similarly-situated insureds have previously obtained. Once one or more proposed coverages have been generated based on the above analysis, a bindable quote associated with each proposed coverage may then be generated. (Step 403).

At this point, the insurance provider (or third-party operating on behalf of the insurance provider) may contact the customer (e.g., for the first time) in order to present him or her with the one or more proposed coverage(s) and corresponding bindable quote(s). (Step 404). As above, this may involve transmitting an email or other text or multimedia message to the customer's communications devices; an agent or other insurance provider representative contacting the customer directly, for example, via telephone; or any other number of manners of communicating with the customer. In one exemplary embodiment, prior to receiving the proposed coverage(s) and bindable quote(s), the customer may first be asked to verify his or her identity and/or the information relied upon to generate the proposed coverage(s) or bindable quote(s).

Upon receiving the one or more proposed coverage(s) and bindable quote(s), as discussed above, the customer may, in one exemplary embodiment (not shown in FIG. 4) be given the opportunity to request a variation or modification of one or more of the proposed coverages. At this point, if the modified proposed coverage is acceptable to the insurance provider or third party (e.g., if the customer qualifies for a requested reduction in deductible), a new bindable quote may be generated and provided to the customer.

Finally, in Step 405, the customer may be enabled to accept the proposed coverage and bindable quote (i.e., either the original proposed coverage and corresponding bindable quote, or the modified coverage and quote). As above, this may be done by providing a link to a web site through which the customer can accept the proposed coverage and bindable quote, providing a phone number he or she can call, or simply allowing the customer to communicate his or her acceptance to the agent or representative who has contacted him or her directly. In one exemplary embodiment, the acceptance may be provided without the prospective purchase being required to provide any additional information. In other words, according to one exemplary embodiment, a customer may be identified, the needs of that customer, as well as what coverage types and amounts are best suited for the customer may be determined, and the customer may be offered and accept a proposed coverage and bindable quote, all without having to provide any information. Exemplary embodiments of the present invention, therefore, provide a quick and efficient means by which a potential customer can acquire insurance coverage.

Those skilled in the art will understand that insurance providers may seek to market insurance to businesses as well as individual people in the manner described in connection with FIG. 4.

In one exemplary embodiment of the invention, a customer may be offered a customary discount upon accepting coverage in two or more policies, for example, both a homeowners and an automobile policy. In the case of an existing insured, accepting an additional policy may result in premium discounts for both the existing and the new policy.

### CONCLUSION

As noted above, the method, computer program product and system of exemplary embodiments provide a benefit over the known prior art by, among other things, alleviating the burden placed on an insured to detect changes that may have occurred to the insured's overall insurance needs, especially during the term of an existing policy. Exemplary embodiments proactively detect and notify the insured of the change and provide the insured with recommendations for reacting thereto. Exemplary embodiments enable countless data sources to be accessed simultaneously and according to a predetermined schedule, as well as enable numerous factors affecting the insured's insurance needs and risk exposure to be considered all at one time. The method of exemplary embodiments provides for increased consistency among notifications and recommendations, since it is not dependent upon the diligence of the particular agent involved. As a result of the foregoing, according to exemplary embodiments, better, more accurate and more consistent recommendations can be provided.

As described above and as will be appreciated by one skilled in the art, embodiments of the present invention may be configured as a method or system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method of proactive insurance marketing, said method comprising:
automatically monitoring a plurality of data sources comprising a plurality of data records with information on one or more life events, one or more economic events, or both related to a customer;
automatically detecting, based at least in part on the monitoring of the plurality of data sources, an occurrence of a triggering event by at least one computing device comprising at least one processor, the triggering event comprising at least one of a life event or an economic event that indicates a change in insurance needs of the customer, the change in insurance needs addressable by a particular insurance product for the customer, the step of automatically detecting the occurrence of the triggering event comprising:
generating a new profile for the customer based at least in part on the triggering event, and
comparing the new profile to a previous profile for the customer to determine if the insurance needs of the customer have changed, wherein the previous profile for the customer does not include the triggering event;
in response to automatically detecting the occurrence of the triggering event, identifying an insurance policy for the particular insurance product based at least in part on the change in insurance needs of the customer by the at least one processor;
conducting an underwriting analysis of the customer, by the at least one processor, based on underwriting information comprising at least in part the life event or the economic event indicating the change in insurance needs that caused the occurrence of the triggering event and without requesting or receiving any information directly from the customer that would be used for performing the underwriting analysis;
generating a proposed amount of coverage provided by the particular insurance product based on the underwriting analysis by the at least one processor;
automatically generating a bindable quote for the proposed amount of coverage from the detection of the occurrence of the triggering event; and
causing presentation of the corresponding bindable quote for the proposed amount of coverage to the customer,
wherein the underwriting information used to conduct the underwriting analysis and specific to the proposed amount of coverage is obtained, at least in part, from the plurality of data records and is not obtained directly from the customer prior to presenting the customer with the proposed amount of coverage and corresponding bindable quote.

2. The method of claim 1 further comprising:
enabling the customer to request a variation of the proposed coverage in order to generate a new proposed coverage; and
generating a new bindable quote for the new proposed coverage by the at least one processor.

3. The method of claim 1 further comprising:
enabling the customer to accept the proposed coverage and corresponding bindable quote.

4.-5. (canceled)

6. The method of claim 1, wherein the steps of the method are carried out by an insurance provider and the customer is currently insured by the insurance provider.

7. A computer program product for proactive insurance marketing, wherein the computer program product comprises at least one non-transitory computer-readable storage medium having computer-executable program code stored therein, the computer-executable program code, when executed by a computer, causes the computer to:
automatically monitor a plurality of data sources comprising a plurality of data records with information one or more life events, one or more economic events, or both related to a customer;
automatically detect, based at least in part on the monitoring of the plurality of data sources, an occurrence of a triggering event comprising at least one of a life event or an economic event that indicates a change in insurance needs of the customer, the insurance needs addressable by a particular insurance product for the customer, the automatic detection of the occurrence of the triggering event comprising:
generating a new profile for the customer based at least in part on the triggering event, and
comparing the new profile to a previous profile for the customer to determine if the insurance needs of the customer have changed, wherein the previous profile for the customer does not include the triggering event;
in response to automatically detecting the occurrence of the triggering event, identify an insurance policy for the particular insurance product based at least in part on the change in insurance needs of the customer;
conduct an underwriting analysis of the customer based on underwriting information comprising at least in part the life event or the economic event indicating the change in insurance needs that caused the occurrence of the triggering event and without requesting or receiving any information directly from the customer that would be used for performing the underwriting analysis;
generate a proposed amount of coverage provided by the particular insurance product based on the underwriting analysis;
automatically generate a bindable quote for the proposed amount of coverage from the detection of the occurrence of the triggering event; and
cause presentation of the corresponding bindable quote for the proposed amount of coverage to the customer,
wherein the underwriting information used to conduct the underwriting analysis and specific to the proposed amount of coverage is obtained, at least in part, from the plurality of data records and is not obtained directly from the customer prior to presenting the customer with the proposed amount of coverage and corresponding bindable quote.

8. The computer program product of claim 7, wherein the computer-executable program code, when executed by the computer, causes the computer to:
enable the customer to request a variation of the proposed coverage in order to generate a new proposed coverage; and
generate a new bindable quote for the new proposed coverage.

9. The computer program product of claim 7, wherein the computer-executable program code, when executed by the computer, causes the computer to:
enable the customer to accept the proposed coverage and corresponding bindable quote.

10.-11. (canceled)

12. The computer program product of claim 7, wherein the computer is associated with an insurance provider and the customer is currently insured by the insurance provider.

13. A system for proactive insurance marketing, said system comprising:
a processor; and
a memory in communication with the processor, said memory storing an application executable by the processor, wherein the processor, upon executing the application, is configured to:
automatically monitor a plurality of data sources comprising a plurality of data records with one or more life events, one or more economic events, or both related to a customer;
automatically detect, based at least in part on the monitoring of the plurality of data sources, an occurrence of a triggering event comprising at least one of a life event or an economic event that indicates a change in insurance needs of the customer, the insurance needs addressable by a particular insurance product for the customer, the automatic detection of the occurrence of the triggering event comprising:
generating a new profile for the customer based at least in part on the triggering event, and
comparing the new profile to a previous profile for the customer to determine if the insurance needs of the customer have changed, wherein the previous profile for the customer does not include the triggering event;
in response to automatically detecting the occurrence of the triggering event, identify an insurance policy for the particular insurance product based at least in part on the change in insurance needs of the customer;
conduct an underwriting analysis of the customer based on underwriting information comprising at least in part the life event or the economic event indicating the change in insurance needs that caused the occurrence of the triggering event without requesting or receiving any information directly from the customer that would be used for performing the underwriting analysis;
generate a proposed amount of coverage provided by the particular insurance product based on the underwriting analysis;
automatically generate a bindable quote for the proposed amount of coverage from the detection of the occurrence of the triggering event; and
cause presentation of the corresponding bindable quote for the proposed amount of coverage to the customer via a computer interface,
wherein the underwriting information used to conduct the underwriting analysis and specific to the proposed amount of coverage is obtained, at least in part, from the plurality of data records and is not obtained directly from the customer prior to presenting the customer with the proposed amount of coverage and corresponding bindable quote.

14. The system of claim 13, wherein the processor, upon executing the application, is further configured to:
enable the customer to request a variation of the proposed coverage in order to generate a new proposed coverage; and
generate a new bindable quote for the new proposed coverage.

15. The system of claim 13, wherein the processor, upon executing the application, is further configured to:
enable the customer to accept the proposed coverage and corresponding bindable quote.

16.-17. (canceled)

18. The system of claim 13, wherein the system is operated by an insurance provider and the customer is currently insured by the insurance provider.

19. The method of claim 1, wherein the triggering event is an event from the group consisting of: (1) a purchase of an item by the customer eligible for insurance coverage; (2) a change in level of income for the customer; (3) the customer turning a predetermined age; and (4) a change in value of an insured item.

20. (canceled)

21. The method of claim 1 further comprising the step of retroactively covering a loss in accordance with the proposed amount of coverage, the loss occurring during the time period between the occurrence of the life event or economic event and the customer being presented the bindable quote for the proposed amount of coverage and having an opportunity to accept or decline the proposed amount of coverage, wherein the loss is associated with the life event or economic event.

22. The method of claim 1, further comprising receiving information indicating the customer has experienced, between detection of the triggering event and a predetermined time after the customer has been presented the proposed amount of coverage and corresponding bindable quote, a loss within the proposed amount of coverage, and compensating the customer for the loss based on the proposed amount of coverage.

23. The computer program product of claim 7, wherein a loss occurring during the time period between the occurrence of the life event or economic event and the customer being presented the bindable quote for the proposed amount of coverage and having an opportunity to accept or decline the proposed amount of coverage is retroactively covered in accordance with the proposed amount of coverage, the loss associated with the life event or the economic event.

24. The computer program product of claim 7, wherein the customer experiences, between detection of the triggering event and a predetermined time after the customer has been presented the proposed amount of coverage and corresponding bindable quote, a loss within the proposed amount of coverage, and the customer is compensated for the loss based on the proposed amount of coverage.

25. The system of claim 13, wherein a loss occurring during the time period between the occurrence of the life event or economic event and the customer being presented the bindable quote for the proposed amount of coverage and having an opportunity to accept or decline the proposed amount of coverage is retroactively covered in accordance with the proposed amount of coverage, the loss associated with the life event or the economic event.

26. The system of claim 13, wherein the customer experiences, between detection of the triggering event and a predetermined time after the customer has been presented the proposed amount of coverage and corresponding bindable quote, a loss within the proposed amount of coverage, and the customer is compensated for the loss based on the proposed amount of coverage;
wherein the underwriting information used to conduct the underwriting analysis and specific to the proposed amount of coverage is not obtained directly from the customer prior to presenting the customer with the proposed amount of coverage and corresponding bindable quote.
